(19) United States
(12) Patent Application Publication
(10) Pub. No.: US 2008/0072494 A1
(43) Pub. Date: Mar. 27, 2008

(54) Micronutrient elicitor for treating nematodes in field crops

(76) Inventors: Richard J. Stoner, Berthoud, CO (US); James C. Linden, Loveland, CO (US)

Correspondence Address: RUTH EURE, 4795 EDISON AVENUE, BOULDER, CO, 80301, US

(21) Appl. No.: 11/517,035

(22) Filed: Sep. 7, 2006

(51) Int. Cl. A01G 9/08

(52) U.S. Cl. 47/1.1 R

(57) ABSTRACT

A liquid micronutirent elicitor involving a cell to cell signal transduction system within a plant which is applied to propagules (seed and/or plant) causes natural defensive responses to be produced by the seed and/or plant. This substance may exist as a seed coating, irrigation water, and/or foliar spray for a period of time so that the propagules may have enhanced disease control until the propagule develops sufficiently to fend for itself against parasitic nematodes. The benefits of incorporating the solution include increased vigor, blooms, and harvests. Crops include legumes including soybeans, as well as wheat, canola, corn, peanuts, sunflowers, peppers, tomatoes, grapes, and potatoes.

### I. TECHNICAL FIELD OF THE INVENTION

Generally this invention relates to organic techniques for eliciting plants to suppress parasitic nematodes in field crops.

### II. BACKGROUND OF THE INVENTION

The present invention utilizes techniques that provide primary recognition of pathogen associated molecular patterns and signal transduction inner-polarity to induce natural physiological chemical engines within plants, including defining oligomers as anions of minerals and as elicitors of these natural physiological chemical engines. The focus of the invention is the suppression of plant environmental stresses and pathogens including parasitic nematodes, which infect crops, such as soybeans, under field conditions.

In any crop production endeavor, it has been desirable to produce not only high quantities, but also disease-free yields. These goals can be fairly easy to achieve or may be quite difficult depending upon the specific plant types involved. Often the farmer need only plant the beneficial specimens in a nurturing environment. The cultivars themselves then may develop relatively free from disease with little outside assistance. This can be especially true for cultivars or propagules that are reproduced through seed propagation. Some of the time, a seed coating is applied and acts as a protective environment, which allows the juvenile propagule not only to be stored relatively disease free, but also to begin its growth in a somewhat protected environment. The problem of disease control is, however, much more challenging for propagules that are vulnerable to attack by nematodes.

Commercial crops are vulnerable to a variety of diseases, and disease control can be acute. In spite of these needs, there is also a need to minimize the utilization of chemicals, chemically-formulated pesticides, chemically-formulated additives, and the like with respect to food production. It has become very desirable for crop production intended for consumptive use to be grown organically or as natural as possible. Organic implies without employment of chemically-formulated substances or at least to be grown in an environment which minimizes the utilization of unnatural effects such as the use of chemically-formulated pesticides (fungicides, insecticides and herbicides), genetically engineered changes, irradiation, and the like. While the desirability of a completely naturally grown product can rarely be debated, the actual implementation of these desires has, on a large scale, been very difficult to realize until the present invention. This has been especially true for crops susceptible to parasitic nematodes. The present invention presents a non-systemic means for controlling disease, which may have particular applicability to soybean, bean, pea. trefoil, corn, wheat, oats, barely, rice, clover, cowpea, ground cherry, sesbania, lespedeza, lupine, and geranium crops.

As mentioned, the desire for disease control has existed for years. Until the present invention two key techniques were prevalent for crops. The regulatory approach attempts to minimize the spread of undesirable diseases and has met with only limited success. There still exist outbreaks of disease. Naturally, these vary in location and time. Basically it simply has not been possible to completely eliminate the spread of disease through regulatory approaches. In addition, as markets have evolved the demand for crops, which are less likely to contain any disease, has increased.

The second approach to the problem of disease control has been very traditional—the use of pesticides. Often, this solution has not always been acceptable; consumers have expressed a desire for organically grown produce free of pesticides. In addition, the use of pesticides, although often fairly effective, has been accompanied by other problems. First, the pesticides need to be applied. This can be challenging in that broadcast application on a field basis may not provide the concentrated amount necessary at the particular plant. Second, to the extent the pesticide does not break down and remains in the soil, it may produce byproducts, or residual pesticide which can pose a problem of contamination. Thus pesticides can often result in unacceptable contamination of the remaining soils after the crop has been harvested.

The present invention takes an entirely different approach to the problem of the disease control. It presents a system which utilizes naturally occurring, organic substances that are not chemically-formulated, are not harmful to the propagule and yet trigger that propagule's own natural defense mechanisms. Thus, the propagule itself is prompted to provide defensive substance(s) in the vicinity of the propagule. In the case a disease producing organism (bacterium, fungus and/or nematode) enters this vicinity, it is controlled even before the propagule may sense its presence. This is an entirely different approach from the main efforts in this field. By utilizing a known, naturally occurring trigger substance such as chitin, the invention acts in a manner to intensely trigger the plant's natural defensive mechanisms. Although the stimulating substances may have been known for years, causing an intense stimulation by the present invention an entirely different and unexpected result is achieved.

As mentioned, others may have utilized the particular substances involved. Even those inventions, which had utilized the chitin material, utilized it for vastly different purposes and had not applied it in the micro control manners of the present invention. Their techniques were not directed toward and have not achieved the unique results of the present invention. Rather they have sought completely different results. For instance, U.S. Pat. Nos. 4,812,159 and 4,964,894 to Freepons each sought to utilize chitosan (deacetylated chitin) to change the growth of specific plants. Contrary to the goals of the present invention, these references were aimed at altering a plant's natural growth and development; they also involved applying chitin at levels thousands of times greater than the present invention. Similarly, the present invention takes an entirely different approach from that disclosed in U.S. Pat. No. 4,940,040 to Suslow, in which genetically-altered bacteria were placed near a plant. The resultant man-made bacterial strains of Suslow took an entirely different direction from the organic approach of the present invention. Perhaps most illustrative of the vastly different directions taken by some is contained in U.S. Pat. No. 4,670,037 to Kistner. Somewhat like the Suslow reference, this reference involved intentionally placing a fungus near certain plants. Again it is directed away from the direction of the present invention as it is the separate organism, not the propagule, which accomplished the desired result. The Kistner reference also did not address the need for disease control; instead it might be characterized as tempting fate (let alone regulatory requirements) by purposefully placing a fungus near the plant.

While there has unquestionably been a long-felt need to control diseases for field crops, this need has not been completely satisfied, even though the implementing substances and elements of the present invention had long been available. The inability of those skilled in the art to view the problem from the perspectives of the present inventors has, perhaps, been in part due to the fact that prior to the present invention those skilled in the art had not fully appreciated the nature of the problem. Rather than considering the possibility of an organic solution to the problem, the acute nature of the problem may have caused those skilled in the art to focus upon the pesticide approach mentioned earlier. They apparently had not fully appreciated that the problem of disease control could be achieved through organic natural means. While substantial attempts had been made by those skilled in the art to achieve disease control, the mechanism that is the underpinning of the present invention and results it has been able achieve have not fully been understood.

Rather than taking the approach of utilizing a substance which stimulates the propagule's own natural defensive mechanisms, those skilled in the art actually taught away from this direction by utilizing an external substance which in itself controls the disease. Perhaps especially with respect to the present invention, the results achieved have been somewhat unexpected because those skilled in the art had utilized similar substances on similar propagules without the ability to achieve the results of the present invention. This has been attended by some degree of disbelief and incredulity on the part of those skilled in the art, however, by expanding the fundamental understanding of the mechanisms within the plant itself, the present invention may not only convince those skeptical of its approach, it may also cause further progress in this area.

U.S. Pat. No. 5,726,123 to Heinsohn et al, teaches the use of a mixture of chitosan olilgomers and chitosan salt to plants to increase yields. This reference is incorporated herein in its entirety to the extent it does not teach away from the present invention.

U.S. Pat. No. 6,972,285 B2 to Chang is directed to a method of preparing concentrated aqueous slurry solutions of a polyglucosamine such as chitin or chitosan and peroxide, and adding copper for use as fungal control agents.

U.S. Pat. No. 5,554,445 to Struszczyk and Kivekas is directed to a method for seed encrusting with a film coating of liquid polymer dispersion of microcrystalline chitosan as a seed encapsulant.

U.S. Pat. No. 6,589,942 B1 to Ben-Shalom and Pinto is directed to chitsoan metal chelate complexes as a method for controlling fungal and bacterial diseases in plants.

U.S. Pat. No. 5,965,545 to Ben-Shalom and Platt is directed to compositions and methods for controlling fungal and bacterial diseases in plants using a combination of chiosan and beta-glucosamine.

### III. SUMMARY OF THE INVENTION

The present invention utilizes techniques that provide primary recognition of pathogen associated molecular patterns and signal transduction inner-polarity to induce natural physiological chemical engines within plants including defining oligomers as anions of minerals and as elicitors of these natural physiological chemical engines. The focus of the invention is the suppression of plant environmental stresses and pathogens, including parasitic nematodes that infect many crops under field conditions.

As used herein, the term “elicitor” means the following. Elicitors are stimuli of biotic and abiotic types. For example, the latter are represented by natural stresses to the plant from touch, shear forces (wind), temperature shocks and osmotic stresses. Biotic elicitors include glucan polymers, glycoproteins, low molecular weight organic acids, fungal xylanases and cell wall materials and segments of bacterial flagella. High affinity binding sites have been characterized for oligo-β-glucosides, such as oligochitins, oligochitosans, yeast N-glycan and β-1, 4-linked galacturonate oligomers⁵. The stimuli are perceived by receptors on the plant cells, which lead to activation of secondary messengers that transmit signals into the cell through signal transduction pathways that ultimately results in gene expression and the biochemical changes that benefit the plant. Interplay of the signaling molecules also regulates the entire pathway by factors, which influence signal transduction pathways. These factors include polyamines, calcium, jasmonates, salicylates, nitric oxide and ethylene.

As used herein, the term “propagule” refers to any material from which a plant or crop can grow and contains genetic information for the eventual replication of cells. Examples of propagules include, but are not limited to plants, cuttings, grafts, seedlings, roots, tubers, or any other plant material which contains genetic information for growth and development. A “pregermination propagule” refers to a propagule which has not yet germinated, such as a seed, for example.

The present invention discloses both the fundamental understandings and some specific arrangements that achieve a level of organic disease control for a propagule. The present invention also discloses arrangements which can achieve enhancement of emergence and yield for propagules. The present invention further discloses arrangements which increase the subsequent growth rate. The disclosed arrangement permits the goals of disease control, enhanced emergence and yield to be achieved individually or in combination. In its preferred embodiment, the invention involves a system including seed treatment of the propagule. In an embodiment, this systems includes an elicitor. This elicitor seed treatment may include an intense stimulus, or elicitor, such as chitin. In addition, chitosan may also be used. While chitosan is not strictly an organic substance, it provides many of the advantages, albeit to different degrees, as chitin. The solubilized form of chitosan, which is the micronutrient of the present invention, is an intense stimulus that is not only non-damaging to the propagule, but also acts through various means to cause the propagule itself to release an amount of naturally defensive substance(s). Naturally defensive substances may, of course, include both substances that the propagule naturally is capable of releasing as well as those naturally defensive substances that may be produced as a result of genetic manipulations in which the gene(s) for such substances are introduced into a plant's genetic material.

The naturally defensive substance is released regardless of whether there is any disease present and is kept within the vicinity of the propagule, so it is available when needed. Importantly, the naturally defensive substance is sufficient to disable or destroy the disease's ability to negatively impact the propagule. The invention also encompasses techniques for varying the system to accommodate a great variety of specific propagules, diseases, and needs. Once the disease is disabled, the system can automatically avoid impacting the propagule's growth. The propagule is allowed to naturally develop free from the effects of the disease. In this fashion, a very natural result is achieved. The system may thus assure an organically grown, naturally developed product.

Accordingly, it is an object of the invention to achieve a natural and effective method for disease control for organized living cells. This includes propagules of those members of the plant kingdom that are of commercial interest. Thus, a goal is to avoid the use of chemicals such as pesticides, to avoid any genetic changes within the propagule itself, and to utilize the plant's own defensive capability in achieving disease control. In keeping with this general goal, a more specific goal is to provide an insulated impact on the plant. Thus, one goal is to allow an external stimulus to trigger the propagule's own processes and achieve disease control. Similarly, another goal is to avoid any change in the natural growth development of the propagule. The present invention avoids any genetic changes and merely triggers the propagule's own natural processes. A further goal is to allow the plant to develop naturally and not have any changes except that of keeping the disease from negatively impacting the propagule's development. Thus a goal is to allow the plant to grow naturally without either a positive or a negative impact on its own developmental cycles. Another broadly stated goal of the present invention is to provide a protection which lasts until the propagule is ready to do without that protection. In keeping with this goal the present invention affords treatments, which may exist over a several week period until that propagule has grown. Naturally, this is achieved while avoiding any utilization of potentially harmful substances.

Yet another general goal of the invention is to minimize the impact on the growing environment. Thus, the invention concentrates its effects at the most important locations, near the propagule. This may reduce field application costs, and may avoid the residual impacts of using a broadly applied substance. In order to achieve this specific goal, it is a goal to avoid any application of the end disease control substance. Rather the goal is to utilize a naturally occurring intermediate substance that triggers the plant to achieve its own disease control.

An additional general goal of the invention is to utilize propagule treatments to enhance plant emergence and yield of plant product. Specifically, it is a goal to use propagule seed treatment to enhance emergence and/or foliar or irrigation treatments to enhance yield separately or in addition to disease control, which in the literature is referred to as induced systemic resistance.

A further goal is to develop a system which can enhance propagule growth separately or in combination with disease control or enhancement of emergence, increase flowering, fruiting and yield.

A further object of the invention is to incorporate regulatory, unknown, and psychological factors which lead to broad commercial acceptance. Thus, the invention has as a goal the utilization of naturally occurring substances to cause the triggering of the effect within the tissue itself. This is achieved through an insulated approach whereby a stimulus acts through several different mechanisms before causing the existence of the naturally defensive substance. Thus, the placement of unnatural, potentially harmful, or otherwise unnecessary substances near the propagule is completely avoided. In keeping with this goal, it is an object of the invention to afford advantages to the grower, who is charged with actually implementing the system.

It is a still further object of the present invention to provide a method for controlling parasitic nematodes in field crops that incorporates applying a substance to the foliage of a propagule.

It is a still further object of the present invention to provide a method for controlling parasitic nematodes in field crops which incorporates applying a substance to the soil wherein a propagule is planted.

It is a still further object of the present invention to provide a method for controlling parasitic nematodes in field crops which incorporates treating the seed of the crop with a substance.

It is a still further object of the present invention to provide a substance which can be applied to the foliage of propagule of a field crop which causes the propagule to produce a naturally defensive substance against disease.

It is a still further object of the present invention to provide a substance which can be applied to the soil in which a propagule of a field crop is planted which causes the propagule to produce a naturally defensive substance against disease. It is a still further object of the present invention to provide a substance which can be applied to the seed of a field crop which causes the propagule emerging from the seed to produce a naturally defensive substance against disease.

It is a still further object of the present invention to provide a substance which can be applied in any combination of the above to a field crop for either controlling parasitic nematodes and for production of a naturally defensive substance against disease.

Additionally, the micronutrient of the present invention operates as a homeopathic chemical engine. As such it operates as follows:

Contact of the micronutrient of the present invention with receptors on the plant cell surface initiate signal transduction pathways, which either elevate or diminish expression of certain enzymes. These enzyme activities may promote the following processes:

1. Plants produce various secondary metabolites that allow interaction with the environment. Elicitors can enhance these and/or second messenger development. The interplay of elicitors, secondary metabolites and second messengers enables the plant to better overcome biotic and abiotic (environmental) stresses through a process known as signal transduction.

2. Interplay of the signaling molecules important to nematodes, rhizobia and mycorrhiza (microorganisms) interaction is represented by a class of compound called flavonoids.

3. The plants make flavonoids to signal these microorganisms.

4. These microorganisms may all make nod-factors, which dictate specificity between plant roots and nematodes, rhizobia or mycorrhiza.

5. Nod-factors contain chitin oligosaccharide components. This might be a common element with the composition of the micronutrient of the present invention.

6. The process of making the micronutrient of the present invention. might yield some flavonoid mimics.

7. The micronutrient of the present invention may therefore contain elements necessary for both sides of the interaction, i.e. for the signaling from the plant and the specificity from the microorganisms.

The micronutrient of the present invention does not control nematodes. It is an elicitor of plant induced suppressant of nematodes and other pathogens. It suppresses growth of parasitic nematodes in the vicinity of the developing propagule or seed without harming beneficial nematodes. The elicited output of the chemical engine via the signal transduction switch and growth properties suppresses the parasitic nematode. In contrast, methyl bromide destroys both beneficial nematodes and parasitic nematodes, as well as rhizobial and microrhizal forms, which are extremely beneficial to the nutrition of plants, particularly leguminous plants. Methyl bromide is extremely harmful to humans and the environment and is expected to be prohibited by the EPA. Chitin/chitosan based products containing up to 100% activated materials are also used to destroy both harmful and beneficial nematodes as well.

An additional feature of the chemical engine is its ability to improve crop quality in the presence of other field borne pathogens. See data from Mexico, set forth hereinbelow. Treatments of the micronutrient of the present invention have reduced by as much 10 kilograms per hectare of dangerous chemical pesticides on potatoes.

Crops suitable for use with the present invention include, but are not limited to: legumes including soybeans, as well as wheat, canola, corn, peanuts, tobacco, sunflowers, peppers, tomatoes, potatoes, lettuce and sweet clover.

Naturally, further objects of the invention are disclosed throughout other areas of the specification and claims.

### IV. DETAILED DESCRIPTION OF THE INVENTION

The micronutrient of the present invention is an all-natural plant amendment derived from chitin/chitosan and is 100% water soluble, whereas chitin/chitosan is not water soluble. Chitin/chitosan occurs naturally in a range from 100% chitin to 100% chitosan as a mixed polymer. By contrast, an NMR analysis of the micronutrient of the present invention revealed characteristics of approximately 20% chitin and approximately 80% chitosan. Below is data showing that the micronutrient of the present invention outperforms chitin/chitosan as an elicitor of self-protecting enzymes.

One of the classical responses to elicitation of plants is induction of certain enzyme activities. These may
1) enhance seed germination by increasing enzymes for degradation of polymers in the seed,
2) promote and elevate seedling vigor to boost stand quality and health, which establishes root systems earlier and more foliage, to stimulate production of greater yields,
3) make available agents (e.g. enzymes and phytoalexins) that resist bacteria, fungi and insects, fight pathogens and destroy parasitic nematodes,
4) develop chemical engines that stimulate advanced mechanisms to overcome environmental stress, e.g. mineral imbalances, hail, drought or wind damage, insect & pathogen stresses and
5) delay senescence by suppression of ethylene action, which allows more complete product development before harvest.

Enzyme activity measurements relate to the level of a given enzyme protein in the plant tissue. As an example of enhanced enzyme activity, β-1,3-glucanase was measured. The enzyme, β-1,3-glucanase, was assayed using laminarin (a soluble β-1,3-glucan) as substrate. Crude homogenates of the seedlings from treated seeds yielded the data in FIG. 1. Increased β-1,3-glucanase activity compared to controls (without seed treatment) was obtained in the micronutrient of the present invention treatments ten days following germination. Elicitation of mung beans seeds that were treated with the micronutrient of the present invention were compared to those treated with two types of elicitors. First, various concentrations of purified colloidal chitin/chitosan were used. The dose response to chitin/chitosan concentrations of 9, 0.9 and 0.09 mg/seed followed no regular pattern. A nearly equivalent concentration of the micronutrient of the present invention (1 mg/seed) elicited five times as much β-1,3-glucanase enzyme activity. Secondly, lower concentrations of the chitin oligosaccharide containing six glycan moieties, N-acetylchitohexaose were studied. The importance of the chitin oligosaccharide is that short chains of chitin have been found optimal in elicitation of many types of plants. The dose response relationship to the oligosaccharide concentrations of 0.5, 0.05 and 0.005 mg/seed is negative; i.e. higher doses resulted in lower specific enzyme activities. Comparisons similar to those with chitin/chitosan could be made between the performance of 1 mg/seed micronutrient of the present invention and lower concentrations of the more optimal oligosaccharide.

A dose response for the micronutrient of the present invention in induction of elevated β-1,3-glucanase activity in adzuki beans is demonstrated by data in FIG. 2. Induction of this enzymatic activity increases with quantity of micronutrient of the present invention applied to the seeds. Comparison of elicitation between treatments with 0, 0.5, 1.0 and 2.0 mg/seed and controls in specific enzyme activity was evaluated in both hypocotyl and epicotyl tissues.

The specific enzyme activities in both tissues increased with dosage 21 days after germination. The differences become significant in root tissue using 2.0 mg/seed with twice the level of activity, compared to controls.

### Comparisons of Germinating Mung Beans Elicitation Following Seed Treatment with Micronutrient of the Present Invention and Chitinichitosan Elicitors

### Comparisons of Germinating Adzuki Beans Elicitation Following Seed Treatment with Various Concentrations of Micronutrient of the Present Invention

Further analysis of the micronutrient of the present invention revealed that the if using the micronutrient of the present invention for irrigation treatment, application on the order of 1-10 mg micronutrient per gallon of water is a suitable concentration and use of about one pint of this mixture per acre is sufficient to protect most crops. The same concentration of about 1-10 mg micronutrient per gallon of water is a suitable concentration for foliar treatment as well as a seed dip. Use of the micronutrient of the present invention as an irrigation or foliar treatment provides contact of the micronutrient with receptors on the plant cell surface, which initiates signal transduction pathways and enhances vigor of seedlings. These processes lead to earlier and more robust root systems, earlier and more robust foliage, which provide more development in a growing period and produce greater crop yields.

The signal transduction brought about by contact of the micronutrient of the present invention with cell surface receptors on a plant further enhance growth and crop yield by inducing the plant to generate protective enzymes and phytoalexins for resistance to bacteria, fungi, entomologic attack, other pathogens and suppression of parasitic nematodes.

The signal transduction brought about by contact of the micronutrient of the present invention with cell surface receptors on a plant further enhance growth and crop yield by allowing the plant to stimulate production of chemical engines in the golgi bodies and mitochondria which enhance the plant's ability to withstand and overcome environmental stress such as mineral imbalances, hail, drought, wind and pathogenic and entomologic stresses.

The signal transduction brought about by contact of the micronutrient of the present invention with cell surface receptors on a plant further enhance growth and crop yield by increasing the effective growing period by delaying senescence by suppressing the action of ethylene, thereby allowing more complete crop development before harvest.

Use of the micronutrient of the present invention as a seed treatment enhances seed germination by increasing the rate of germination as well as the proportion of seeds germinating by increasing enzyme activity, such as alpha-amylase, for example, which degrades polymers in the seed coat. The site of this enzyme activity resides in the aleurone cells, which reside beneath the seed coat.

Additionally, the present invention does not demonstrate a negative physiological impact on field crops. Crops are not hurt by the elicitation or suffer physiological damage or impairment of growth. Only positive results have been observed. Thus the switch in this manner behaves in a positive manner.

Furthermore there is a positive effect on diseases also. Parasitic nematodes did not increase number but decreased in number (Becker, 2005). Thus the switch in this manner is negative as regards disease pressure.

The following discussion describes how the invention works to elicit various chemical engines within field crops. Pathogen associated molecular patterns for nematodes are defined as either good( i.e., beneficial nematode) or bad (i.e., parasitic nematodes).

The signal transduction inner-polarity as elicited by the invention, is a polarity switch or sets of switches comprised to activate the chemical engine(s) within the plant. Some of these may be of the same pole to activate specific enzyme pathways for resisting disease and pathogens but able to not harm good nematodes. The chemical switch in the present invention is of opposite poles; one positive pole activation for resisting infection (Linden, 1998) and a negative pole for not resisting beneficial nematodes (Becker, 2005).

The inner-pole is not limited to opposite elicitation features. The signal transduction inner-pole activations include combinations of polarities. Thus the switch's poles may both be “positive”, eliciting beneficial chemical engines resulting in physiological improvement (increased biomass and yields, higher quality, increased shelf life, etc). We demonstrated under controlled greenhouse conditions the soybean seed counts increased 78% and seed weight increased of 81% over control with seed and irrigation treatments (Linden, 2006).

The switch poles may both be “negative” for elicitation of chemical engines, when the physiological aspects that ward off insects from leaves and stems as well as resisting rhizoctonia disease infection (CSU Potato Field Trials 1995).

Signal transduction inner-polarity can be elicited where there is a combination of multiplexed switches of various poles, each acting independently of one another. In cell biology these concepts are referred to as upregulation, downregulation and signalling crosstalk. Chemical engines result in a wide range of physiological enhancements as well as defending, resisting and overcoming disease and pathogen pressures.

Repeated application of the invention can cause cascading signal transduction inner-polarity activations for greater power of the chemical engines resulting in significant yield increases between multiple applications (Linden, 2006).

The micronutrient of the present invention is applied at different rates depending upon seed size (grams per seed) as shown below. The smaller the seed the less is required for the signal transduction response.

Results for Potato May 5, 2006

| | | | | |
|---|---|---|---|---|
| 5 g | 4.5 ml | 15 ml | 1 mg | 7.5 × 10⁻⁴ mMol |
| | | | | present invention |
| seed | 450 g | 1000 ml | 1 ml | 700 mg |
| 5 | 0.01 ml/g | 0.015 ml | 1 | 1.07 × 10⁻⁶ mMol |
| | | | | present |
| | | | | invention/seed |

Results for Soybean May 30, 2006

| | | | | |
|---|---|---|---|---|
| 0.163 g | 1.25 ml | 5 ml | 1 mg | 5.98 × 10⁻⁷ mMol |
| | | | | present invention |
| seed | 450 g | 3785 ml | 1 ml | 700 mg |
| 0.163 | 0.003 ml/g | 0.001 ml | 1.00 | 8.54 × 10⁻¹⁰ mMol |
| | | | | present |
| | | | | invention/seed |

It is important to note that amounts of the micronutrient of the present invention required to elicit the signal transduction response range from 0.003 to 0.01 ml per gram of seed (depending upon seed size, i.e., seed potatoes weigh more than soybean seeds).

Below is supporting data on a wide range of field crops.

Soybean

### EXAMPLE 1

Central Illinois Agricultural Research Farms, Inc., 1229 W. Edwards, Springfield, Ill. 62704-1634, 800-497-1525 conducted the following experiment. This experiment was conducted at the Henry White Experimental Farm, Field 4, Soybeans, treated and control, Sep. 1, 2005, Lab. No. 25109 and 25106, composite samples from four replications.

### Tissue Test Results and Comments Percent

| | N | P | K | Ca | Mg | S |
|---|---|---|---|---|---|---|
| 4T | 2.92 | .24 | .92 | 1.54 | .25 | .18 |
| 4C | 2.99 | .24 | .98 | 1.42 | .23 | .16 |

### PPM

| | B | Zn | Mn | Cu | Fe | Al | Na |
|---|---|---|---|---|---|---|---|
| 4T | 44 | 35 | 88 | 7 | 55 | 175 | 31 |
| 4C | 40 | 30 | 78 | 5 | 71 | 81 | 22 |

Comments: The most limiting nutrient is Iron (Fe). 8 ratios out of 40 are good. The average deviation is 129 for the treated soybeans and 125 for the control. The deviation is high and indicates that several nutrients are out-of-balance and/or this is a disease scenario. The Becker Nematode Index (BNI) is 83 and 103 respectively. The higher BNI in the control suggests that there are more nematode problems in those strips. Nematode assays were conducted after harvest.

Oct. 11, 2005

Average soybean counts per foot of row in the treated strips=920

Average soybean counts per foot of row in the control strips=776

Nov. 16, 2005

Results of Nematode Assays from the Henry White Experimental Farm Field 4

Nematode Counts, Total and Parasitic of 100 ml of soil. The treatment is 1 pint of the micronutrient of the present invention per acre and there were 4 replications in a paired comparison design.

| | Total | Total | Parasitic | Parasitic |
|---|---|---|---|---|
| Replication | Treated | Control | Treated | Control |
| 1 | 336 | 904 | 40 | 96 |
| 2 | 368 | 312 | 40 | 96 |
| 3 | 416 | 512 | 56 | 120 |
| 4 | 472 | 664 | 40 | 88 |
| Average | 398 ns | 598 ns | 44* | 100* |

ns = no significant difference,
*significantly different at the 99% confidence level

The strips treated with the micronutrient of the present invention averaged 11.0% parasitic nematodes while the control strips averaged 16.7% parasitic nematodes. The two most common parasitic nematodes were lance and lesion. Yield losses can be expected when parasitic levels are higher than 10%.

Soil profile examinations showed compaction problems between 3 and 12 inches deep. Root development was restricted and yields were affected. Control strips averaged 52.2 bushels per acre and the treated strips averaged 53.4 bushels per acre.

A review of the above data shows that the plant signal transduction defense response induced by the micronutrient of the present invention destroys harmful parasitic nematodes. The micronutrient of the present invention has no negative impact on beneficial nematodes and other beneficial micro-organisms.

Soybean

### EXAMPLE 2

Set forth below is greenhouse data on soybean yields conducted at Colorado State University. This data shows a combination of the micronutrient elicitor of the present invention seed and a foliar treatment had 41% increase in yield. Also the yield seeds weighed more than the control seeds by as much as 49%. Treatment #1 is control. Treatment #2 is untreated seed with two irrigated applications. Treatment #3 is treated seed. Treatment #4 is treated seed with two irrigated applications.

CSU SOYBEAN GREENHOUSE Results
2006

| | | Percent | Grams per | Gram increase | | total | |
|---|---|---|---|---|---|---|---|
| Treatment | Increase | increase | seed | per seed | Percent increase | grams | seed |
| 1 | | | 0.540564 | | | | |
| 2 | 8.63 | 17.0% | 0.691248 | 0.150684 | 27.9% | 59.45 | 86 |
| | | | | | | | plants |
| 3 | 18.88 | 37.2% | 0.749381 | 0.208816 | 38.6% | 69.69 | 93 |
| | | | | | | | plants |
| 4 | 20.96 | 41.2% | 0.806388 | 0.265824 | 49.2% | 71.77 | 89 |
| | | | | | | | plants |

Field data results for other crops. note—peanuts had 56% increase in yield).

Seed Treatment
date: Dec. 7, 2005

| | Soybean | % increase | Corn | % increase | Wheat | % increase |
|---|---|---|---|---|---|---|
| treated | 63.9 | | 225.7 | | 50.4 | |
| control | 61.7 | | 210.7 | | 47.9 | |
| delta | 2.2 | 3.57% | 15 | 7.12% | 2.5 | 5.22% |

Tomatoes

A comparison of poor soil conditions for tomatoes found that treatment with the micronutrient of the present invention yielded a 37% increase over control in poorer fields where soil and environmental conditions reduce output. In higher quality fields, where soil and environmental conditions produce higher output, treatment with the micronutrient of the present invention yielded a 24% increase over control. (Project 030410A)

Potato

Potato yields from fungus infected soils from greenhouse and fields in Mexico: In normal soil plants treated with the micronutrient of the present invention had a 27.84% increase in daughter tuber yields over the control group. Treated plants grown in infected soil had a 35.37% increase in daughter tuber yield over the control group.

Control group: applied chemicals/pesticide per manufacturer's recommendations.

Treated group was treated with 1 liter micronutrient of the present invention/1000 liters of water/hectare.

Set forth below are the results of an experiment on the fields of Sr. Ernesto Ortegon Cervera. The crop planted was potato, date of burning of the field was Nov. 27, 2001, date of sowing was Nov. 27, 2001, and the date of harvest was Apr. 4, 2002. The fields were irrigated by rolling irrigators and the fertilizer used was “Propia.” Ortegon is comprised of 0.5 parts Agrimicin, 1.0 part Confidor, 8.0 parts Pentaclor, 5.0 parts Temir and 0.6 parts Tecto 60. The cost of application of Ortegon was $345.68 per hectare while the cost of application of the micronutrient of the present invention was $175.03 per hectare. Units are in tons per hectare.

| Material | | Present |
|---|---|---|
| applied | Zazueta | invention |
| Field 1 | 276 | 262 |
| Field 2 | 134 | 154 |
| Field 3 | 30 | 36 |
| TOTAL | 440 | 452 |

Set forth below are the results of an experiment on the fields of Sr. Salvador Zazueta (Chava). The crop planted was 135 day Snowden (peas), date of burning of the fields was Apr. 8, 2001. date of sowing was Nov. 22, 2001, and the date of harvest was Apr. 18, 2002. The fields were irrigated by aspersion and the fertilizer used was “Propia. ”Sr. Zazueta applied material to his crops which comrpised 1.5 parts Fuvadan 350, 10.0 parts Captan, 5.0 parts Vitamin, 10.0 parts Carbovit, 0.15 parts giberelic acid and 0.8 parts Tecto 60. The cost of application of this mixture was on the order of $265 per hectare while the cost of application of the micronutrient of the present invention was $175.03 per hectare. Units are in tons per hectare.

| | | Ortegon | |
|---|---|---|---|
| Material | | and present | Present |
| applied | Ortegon | invention | invention |
| Field 1 | 267 | 274 | 237 |
| Field 2 | 263 | 259 | 302 |
| Field 3 | 150 | 129 | 172 |
| Field 4 | 22.2 | 22 | 25 |
| TOTAL | 740 | 745 | 781 |

Set forth below are the results of an experiment on the fields of Sr. Enrique Free Pacheco. The crop planted was potato, date of burning of the fields was Mar. 7, 2002, date of sowing was Nov. 22, 2001, and the date of harvest was Apr. 4, 2002. The fields were irrigated by aspersion and the fertilizer used was “Propia.” Sr. Pacheco applied material to his crops which comrpised 2.5 parts Manzate 200, 3.8 parts Cercobin M, 0.75 parts Coprimicin, 19.0 parts Pcnb 80 and 1.75 parts Nuvacron. The cost of application of this mixture was $315.05 per hectare while the cost of application of the micronutrient of the present invention was $175.03 per hectare. Units are in tons per hectare.

| Material | Free | Present |
|---|---|---|
| applied | Pacheco | invention |
| Field 1 | 115 | 160 |
| Field 2 | 83 | 75 |
| Field 3 | 37 | 42 |
| Field 4 | 9 | 11 |
| TOTAL | 279 | 323 |

It is also seen in citrus where the presence of the micro-nutrient of the present invention decrease ethylene production and increased sugar content. The micronutrient of the present invention can also increase shelf life of citrus. Application of 16 oz per acre of the micronutrient of the present invention to the crops, citrus resulted in 10% reduction in citrus decay in packing house resulting in 32% increase in juice grade yields after 5 days of storage.

With respect to the above description, it is to be realized that the optimum relationships for the components of the invention, to include variations in composition, proportion and manner of use, are deemed readily apparent and obvious to one skilled in the art, and all equivalent relationships to those described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact composition and operation shown and described, and accordingly, all suitable modifications and equivalents may be resorted to, falling within the scope of the invention.

1. A propagule planting system that controls disease comprising:
a) a propagule which is selected from the group consisting of: soybean, corn, wheat, barley, oat, rice, legume, canola, peanut, sunflower, pepper, tomato, citrus, and potato;
b) a non-damaging stimulus selected from a group consisting of chitin and chitosan and wherein said non-damaging stimulus is provided in the amount of approximately 3.7 nanograms to 1.1 milligrams for each gram of propagule and wherein said non-damaging stimulus is a stimulus which is not damaging to said propagule, and is provided such that the non-damaging stimulus is at a level:
i) which sufficiently triggers the release of a naturally defensive substance from said propagule so as to protect said propagule from disease and so that said naturally defensive substance is at a greater level than would naturally exist, and
ii) which acts to at least sustain said release of said naturally defensive substance, and
wherein said non-damaging stimulus is also continuously provided in a non-gaseous form in a vicinity of said propagule; and
c) a non-gaseous communication medium wherein said communication medium allows said non-damaging stimulus to affect said propagule.

2. The propagule planting system of claim 1 that controls disease wherein the non-damaging stimulus further comprises:
d) an elicitor within said vicinity of said propagule.

3. The propagule planting system of claim 2 wherein the propagule is large enough for said propagule to develop within the vicinity of said elicitor until said propagule has developed to a point when said propagule is able to withstand disease on its own.

4. The propagule planting system of claim 1 that controls disease wherein the non-damaging stimulus is continuously provided in a vicinity of said propagule and wherein said non-damaging stimulus causes the release of a naturally defensive substance from said propagule and wherein said naturally defensive substance comprises chitinase, beta-1,3 glucanase, protease inhibitors, phenylalanine lyase, chitosanase, PR1 proteins, PR2 proteins, PR3 proteins, PR4 proteins or PR5 proteins.

5. The propagule planting system of claim 2 wherein the propagule is a pre-germination propagule which comprises soybean which has an anticipated germination time; and wherein said non-damaging stimulus is provided in a manner which does not cause said propagule to germinate, wherein said non-damaging stimulus causes the release of a naturally defensive substance, and wherein said non-damaging stimulus is provided in a manner which coordinates the release of said naturally defensive substance with said anticipated germination time.

6. A propagule planting system according to claim 2 wherein the propagule is a pregermination propagule.

7. The propagule planting system of claim 6 that controls disease wherein said naturally defensive substance comprises chitinase, beta-1,3 glucanase, protease inhibitors, phenylalanine lyase, chitosanase, PR1 proteins, PR2 proteins, PR3 proteins, PR4 proteins or PR5 proteins.

8. A propagule planting system that controls disease comprising:
a) a propagule selected from the group consisting of soybean, corn, wheat, barley, oat, rice, legume, canola, peanut, sunflower, pepper, tomato, potato, and citrus;
b) a non-damaging stimulus selected from a group consisting of chitin and chitosan and wherein said non-damaging stimulus is provided in the amount of approximately 3.7 nanograms to 1.1 milligrams for each gram of propagule and in a vicinity of said propagule; and
c) a communication medium wherein said communication medium allows said non-damaging stimulus to affect said propagule.

9. The propagule planting system of claim 8 that controls disease wherein the propagule is a pre-germination propagule, and wherein said non-damaging stimulus is provided in a manner which does not cause said propagule to germinate.

10. An elicitor composition comprising:
78-82% chitosan, 18-22% chitin, and about total nitrogen 0.28%; ammoniacal nitrogen 0.14%; water soluble nitrogen, 0.28%; urea nitrogen <0.5%; water soluble potassium<0.1%; calcium (Ca) 0.05%; available phosphate <0.1%; chloride(Cl) 0.069%; iron (Fe) <0.01%; and sulfur (S) <0.1%.

11. The elicitor composition of claim 10 comprising 5-10 ml of the composition of claim 10 and further comprising 1 gallon of water.

12. A method of treating a propagule comprising application of the composition of claim 11 to the propagule.

13. The method of claim 12 wherein the application is foliar.

14. The method of claim 12 wherein the application is seed coating.

15. The method of claim 12 wherein the application is irrigation.

16. The method of claim 12 wherein the propagule is selected from the group consisting of: soybean, corn, wheat, legume, canola, peanut, sunflower, pepper, tomato, apples, peach, pear, grape, potato, and citrus.
